(19) United States
(12) Patent Application Publication
(10) Pub. No.: US 2002/0070570 A1
(43) Pub. Date: Jun. 13, 2002

(54) Method and apparatus for removing placement elements

(76) Inventors: Thomas Bachthaler, Stokdorf (DE); Richard Numberger, Finsing (DE); Richard Reiser, Muenchen (DE)

Correspondence Address: STAAS & HALSEY LLP, 700 11TH STREET, NW, SUITE 500, WASHINGTON, DC, 20001, US

(21) Appl. No.: 09/912,422

(22) Filed: Jul. 26, 2001

(30) Foreign Application Priority Data
Dec. 12, 2000 (DE) 10061756.5

(51) Int. Cl. B25J 15/06

(52) U.S. Cl. 294/64.1

(57) ABSTRACT

Placement elements are removed from a placement element carrier by a vacuum pipette that is positioned above a placement element and is connected to a vacuum source. An air flow formed at the vacuum pipette causes a force to be exerted on the placement element, which causes the placement element to move toward the vacuum pipette. Consequently, the placement element can be removed from the placement element carrier without jolting.

### BACKGROUND OF THE INVENTION

1. Field of the Invention

The invention relates to a method and an apparatus for removing placement elements from placement element carriers provided with placement elements.

2. Description of the Related Art

In conventional methods for removing placement elements from placement element carriers, a vacuum pipette is lowered from above onto the placement element to be removed. The vacuum pipette touches the placement element to be removed and, in the process, exerts a force on the placement element. Once the vacuum pipette has touched the placement element, a suction channel of the vacuum pipette is connected to a vacuum source. The vacuum generates the holding force required to hold the placement element on the vacuum pipette. Therefore, with the vacuum switched on, the placement element can be removed from the placement element carrier in a manner held on the vacuum pipette.

Both the placement element carrier and the positioning of the vacuum pipette and of the placement element carrier are subject to tolerances, which are unavoidable in particular in the case of placement elements with small housing dimensions. Furthermore, it is desirable for the contact area of the vacuum pipette to be made relatively large in relation to the placement element to be removed, in order to enable a suction channel having a large cross section, which means that, on account of the tolerances, the situation can arise where the vacuum pipette partly presses on the placement element carrier when the vacuum pipette has not been positioned accurately enough above the placement element. As a result, the placement element can be jammed in the placement element carrier, which means that the placement element can no longer be removed. It is also the case with sensitive placement elements having a plurality of connection elements projecting from their housings that an inexactly emplaced vacuum pipette has the consequence that placement elements can no longer be removed or are damaged.

### SUMMARY OF THE INVENTION

An object of the invention is to remove placement elements reliably from a placement element carrier.

This object is achieved by a method for removing placement elements from a placement element carrier by positioning a vacuum pipette at a predetermined distance above a placement element; connecting the vacuum pipette to a vacuum source; and capturing the placement element by a flow that forms on account of a vacuum around the vacuum pipette and sucks the placement element to the vacuum pipette.

In the invention's method for removing placement elements from placement element carriers provided with placement elements, a vacuum pipette is positioned at a predetermined distance above a placement element. The vacuum pipette is subsequently connected to a vacuum source. On account of the flow that forms in the region of the vacuum pipette, the placement element is sucked to the vacuum pipette. According to the method of the invention, the vacuum pipette does not have to touch the placement element to be able to remove the placement element from the placement element carrier. This means that deformations of the placement element carrier cannot occur. Rather, the placement element can be reliably removed without prior mechanical action on the placement element carried out by the vacuum pipette.

It is also possible to connect the vacuum pipette to the vacuum source before the vacuum pipette has been positioned above the placement element. This enables the removal process to be accelerated since the vacuum is already available at the vacuum pipette at the instance at which the vacuum pipette is positioned above the placement element to be removed, and the placement element can thus be removed very quickly.

Furthermore, it is possible to connect the vacuum pipette to the vacuum source after the vacuum pipette has been positioned above the placement element to be removed. This affords the advantage that firstly the predetermined distance can be set exactly and only afterward is the vacuum present at the vacuum pipette. This ensures that the predetermined distance is complied with exactly and, as a result, the functional reliability of the removal process of the placement element is improved.

The predetermined distance may be smaller than the dimensions of the placement element. By way of example, the predetermined distance may be determined before or during operation, or be defined before operation. By way of example, it is possible for the predetermined distance to be determined empirically before operation. The predetermined distance thus determined is then used during operation in that, in a learning cycle, the vacuum pipette is lowered down to the placement element and is then raised by the empirically determined distance from the placement element. This position is used as the desired position for the placement process.

It may also be necessary, however, for the predetermined distance to be freely defined before operation, for example when working with new placement elements or new placement element carriers for which there are no empirical values regarding the distance to be complied with. Furthermore, it may also be necessary to determine the predetermined distance during operation. This may be the case, for example, if the tolerances change during operation due to a change in temperature or wear, so that reliable removal of the placement elements is no longer ensured.

The predetermined distance may be between 0.01 and 1.0 mm.

The predetermined distance is determined for example by the vacuum pipette being connected to the vacuum source and thereupon lowered toward the placement element until the placement element has been sucked from the placement element carrier to the vacuum pipette. Using a measurement system, the distance present immediately before the placement element is sucked to the vacuum pipette can be detected as the predetermined distance. This method can be carried out iteratively, for example, in which case a prescribed value is assumed for the predetermined distance and, through a series of iterations during which the value of the predetermined distance is varied, the value for the predetermined distance is determined in the case of which the reliability with which placement elements are removed or the speed of the removal process is the greatest. It is also possible to connect the vacuum in a regulated manner, for example by using a regulated valve, a regulated vacuum source or a pressure accumulator, to provide reliable and controlled suction of the placement element.

The measurement system may, for example, detect the position of the vacuum pipette. Furthermore, the measurement system may also detect the distance between the vacuum pipette and an exposed surface of the placement element. It is also possible for the measurement system to detect the distance between the vacuum pipette and that surface of the placement element carrier on which the placement elements are exposed.

The measurement system can be used to provide feedback between a prescribed desired value for the position of the vacuum pipette and the present actual value of the position of the vacuum pipette, which can be processed for example by a control apparatus and used in a method according to the invention. The measurement system may be an optical, mechanical, electromagnetic or capacitive measurement system.

According to the present invention, the predetermined distance can be set or determined again for example after at least one removal error has occurred during operation. This ensures that changes occurring during operation are taken into account, thus ensuring maximum removal reliability when removing the placement elements from the placement element carrier.

An apparatus for removing placement elements according to the present invention has a vacuum pipette which is provided with a drive and can be connected to a vacuum source. Placement elements can be removed from a placement element carrier by of the vacuum pipette. A measurement apparatus by which the position of the vacuum pipette can be detected is part of the apparatus of the invention. Furthermore, a control apparatus is provided, which is coupled to the measurement apparatus and by which the drive of the vacuum pipette can be controlled in such a way that the vacuum pipette can remove placement elements from the placement element carrier without jolting. The suction crosssection of the vacuum pipette may have a round, oval or polygonal cross section. Removal without jolting makes it possible for the placement elements that are to be removed to be removed from the placement element carrier without the vacuum pipette previously being brought into contact with the placement elements to be removed. As a result, deformation of the placement element carrier cannot occur. Reliable removal of the placement elements is thus ensured.

The control apparatus of the placement element removal apparatus is suitable, for example, for using the drive to position the vacuum pipette at a predetermined distance above an exposed surface of a placement element. The predetermined distance may be determined empirically, in such a way that the placement elements can be reliably removed.

The measurement apparatus may be integrated for example in the drive of the vacuum pipette. This avoids additional external attachments on the vacuum pipette.

### BRIEF DESCRIPTION OF THE DRAWINGS

The invention is explained in more detail with reference to the drawings, in which:

FIGS. 1a to 1d are cross-sectional views of a vacuum pipette, placement elements and a placement element carrier illustrating a method for removing the placement elements according to the prior art, and

FIGS. 2a to 2d are cross-sectional views of a vacuum pipette, placement elements and a placement element carrier illustrating a method for removing placement elements according to the invention.

### DETAILED DESCRIPTION OF THE PREFERRED EMBODIMENTS

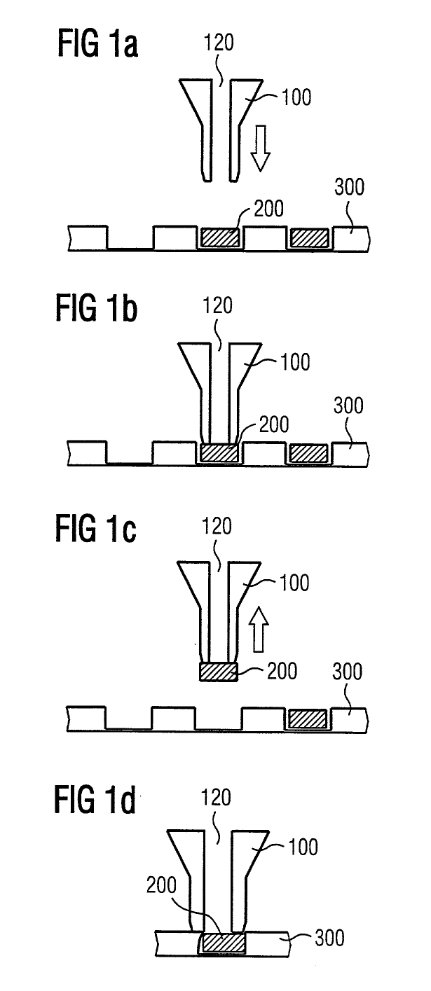

In the conventional method for removing placement elements from a placement element carrier, as can be seen from FIG. 1a, a vacuum pipette 100 provided with a suction channel 120 is moved from above toward a placement element 200 arranged in a placement element carrier 300. As can be seen from FIG. 1b, the vacuum pipette 100 is pressed onto the placement element 200. In this case, the vacuum pipette 100 exerts a force on the placement element 200. Once the vacuum pipette 100 has touched the placement element 200 in the placement element carrier 300, the suction channel 120 of the vacuum pipette 100 is connected to a vacuum source, with the result that the placement element 200 is sucked to the vacuum pipette 100. The placement element 200 fixed on the vacuum pipette 100 in this way can be removed from the placement element carrier 300 by means of the vacuum pipette 100, as can be seen from FIG. 1c.

With ever decreasing dimensions of the placement elements 200, however, problems arise in this method. By way of example, the placement element carrier and also its positioning and the positioning of the vacuum pipette 100 are subject to ever greater tolerances in relation to the dimensions of the placement element 200. As a result, it can happen that the vacuum pipette 100, when being lowered onto the placement element 200, does not exclusively touch the placement element 200 but also the placement element carrier 300. As can be seen from FIG. 1d, in this case it can happen that parts of the placement element carrier 300 are deformed by the force exerted thereon by the vacuum pipette 100, with the result that the placement element 200 is clamped to the placement element carrier 300 and can no longer be removed. This problem area occurs in particular with very small placement elements 200, since in this case vacuum pipettes 100 having very small diameters have to be used in order to avoid contamination of the vacuum pipettes by solder paste or other residues. The force which acts on the placement element carrier 300 is very large on account of the small diameters of the vacuum pipettes. This large force acting on the placement element carrier 300 can then lead to deformations of the placement element carrier 300 which prevents the placement element 200 from being removed.

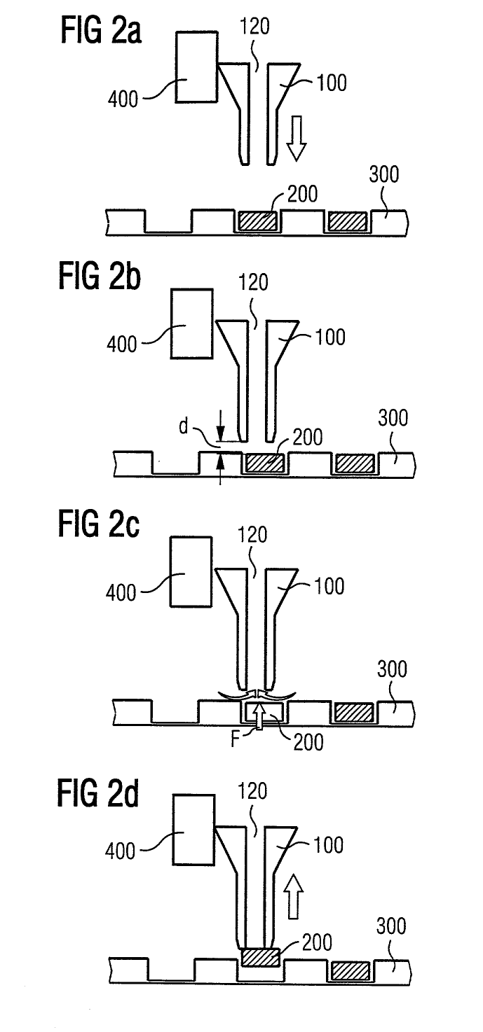

FIGS. 2a to 2d reveal a preferred embodiment of the invention. As can be seen from FIG. 2a, a vacuum pipette 100 provided with a suction channel 120 is lowered onto a placement element 200 arranged in a placement element carrier 300. The position of the vacuum pipette 100 is detected by a measurement system 400, which may be coupled to the vacuum pipette 100. The vacuum pipette 100 is positioned at a predetermined distance d above the placement element 200, as can be seen from FIG. 2b. The distance d is, for example, between 0.01 mm and 1.0 mm, in particular between 0.2 mm and 0.3 mm. During the positioning of the vacuum pipette 100 above the placement element 200 at the predetermined distance d, a certain tolerance of the positioning of the vacuum pipette 100 relative to the position of the placement element 200 is also possible, as can be seen from FIG. 2b. The suction channel 120 is subsequently connected to a vacuum source, with the result that, as can be seen from FIG. 2c, an air flow is produced at the vacuum pipette 100. The air flow causes a force F to be exerted on the placement element 200, which force causes the placement element 200 to be moved toward the vacuum pipette. As can be seen from FIG. 2d, once the placement element 200 has been sucked to the vacuum pipette 100, the placement element 200 can be removed from the placement element carrier by means of the vacuum pipette 100.

Consequently, according to the present invention, removal errors are avoided in particular in the case of small placement elements or sensitive placement elements.

What is claimed is:

1. A method for removing placement elements from a placement element carrier, comprising:
positioning a vacuum pipette at a predetermined distance above a placement element;
connecting the vacuum pipette to a vacuum source; and
capturing the placement element by a flow that forms on account of a vacuum around the vacuum pipette and sucks the placement element to the vacuum pipette.

2. The method as claimed in claim 1, wherein the vacuum pipette is connected to the vacuum source before the vacuum pipette is positioned above the placement element.

3. The method as claimed in claim 1, wherein the vacuum pipette is connected to the vacuum source when the vacuum pipette has been positioned above the placement element.

4. The method as claimed in claim 1, wherein the predetermined distance is smaller than any dimension of the placement element.

5. The method as claimed in claim 4, wherein the predetermined distance is determined one of during and before operation.

6. The method as claimed in claim 5, wherein the predetermined distance is defined before operation.

7. The method as claimed in claim 5, further comprising the step of determining the predetermined distance by:
connecting the vacuum pipette to the vacuum source;
after said connecting, lowering the vacuum pipette toward the placement element until the placement element is sucked from the placement element carrier to the vacuum pipette; and
detecting a position of the vacuum pipette as the predetermined distance using a measurement system.

8. The method as claimed in claim 4, wherein the predetermined distance is between 0.01 mm and 1.0 mm.

9. The method as claimed in claim 8, further comprising detecting a position of the vacuum pipette by a measurement system.

10. The method as claimed in claim 9, wherein said detecting obtains a distance between the vacuum pipette and an exposed surface of the placement element.

11. The method as claimed in claim 9, wherein a distance between the vacuum pipette and a surface of the placement element carrier on which the placement elements lie freely is detected by the measurement system.

12. The method as claimed in claim 9, wherein said detecting is performed after at least one removal error has occurred during operation.

13. An apparatus for removing placement elements from a placement element carrier using a vacuum pipette provided with a drive, comprising:
a measurement unit to detect a position of the vacuum pipette; and
a control unit, coupled to the measurement apparatus, to control movement of the vacuum pipette so that the vacuum pipette can remove at least one placement element from the placement element carrier without jolting.

14. The apparatus as claimed in claim 13, wherein said control unit controls positioning of the vacuum pipette to a distance above an exposed surface of the at least one placement element.

15. The apparatus as claimed in claim 14, wherein said measurement unit is integrated in the drive.
